(19) United States
(12) Patent Application Publication
(10) Pub. No.: US 2025/0369694 A1
(43) Pub. Date: Dec. 4, 2025

(54) ROTARY KILN WITH VACUUM SURFACE AND ITS PRODUCTION METHOD

(71) Applicant: HITIT GÜNES ENERJISI SANAYI VE TICARET ANONIM SIRKETI, Urla, Izmir (TR)

(72) Inventor: Çinar ÖNCEL, Urla, Izmir (TR)

(21) Appl. No.: 18/876,273

(22) PCT Filed: Jul. 6, 2023
(86) PCT No.: PCT/TR2023/050647

§ 371 Date: Dec. 18, 2024

(30) Foreign Application Priority Data
Jul. 6, 2022 (TR) 2022/011152

(51) Int. Cl. F27B 7/06; F27D 99/00

(52) U.S. Cl. CPC F27B 7/06; F27D 99/0073

(57) ABSTRACT

Disclosed is a rotary kiln system with a vacuum surface and a production method thereof. The rotary kiln system has a metal, polymer, or composite jacket coated onto an inner and/or outer surface to make the kiln double walled. A vacuum area remains between the outer surface of the rotary kiln and the jacket where a vacuuming operation is applied. Air sealing members provide the joining of the outer surface of the rotary kiln and the inner surface of the jacket.

### TECHNICAL FIELD

The invention relates to cement sector, ceramic sector.

Invention particularly relates to prevention of heat lost from outer surface of kilns used in sectors using rotating furnace at high temperatures.

### BACKGROUND OF THE INVENTION

Today all industry fields conducting operations at high temperatures and having powder product input use rotary kilns. Outer surfaces of rotary kilns are made from metal which is a material having a high thermal conductivity. Although inside of rotary kilns is coated with refractory materials for heat insulation, rotary kilns are subject to high amount of heat loss from outer surfaces. For instance, the outer surface of a cement rotary kiln operating at 900° C. is around 300° C. and most of this heat can be lost. Various methods are employed to prevent such heat loss or use the heat occurring therein. For example, vacuum isolation panels (VIP) having low thermal conductivity are used to reduce heat loss. Or, the heat generated is transferred by heat exchangers and used to generate hot water and thus hot water obtaining method is applied.

In the state of the art, there are several studies made about heat saving in rotary kilns. The article by Barş et al. entitled “Empirical and Statistical Modelling of Heat Loss from Surface of A Cement rotary Kiln Surface” is about heat losses in rotary kilns. The study entitled “Mathematical modelling of heat recovery from a rotary kiln” by Söğüt et al. provides a mathematical model for heat recycling in rotary kilns. The article entitled “A heat-transfer model for the rotary kiln: Part I. pilot kiln trials” by Barry et al. details heat distribution on walls of the rotary kiln. The study by Engin et al. and entitled “Energy auditing and recovery for dry type cement rotary kiln systems—A case study” reports that energy loss of a rotary kiln for cement production is 40%, that loss from kiln surface is 15% and suggests that a second isolation layer of high cost be coated to reduce the loss. The article entitled “Techno-economic assessment of a rotary kiln shell radiation waste heat recovery system” by Fierro et al. is about a study on regaining the heat lost from rotary kiln surface.

US patent document numbered U.S. Pat. No. 5,695,329A suggests an extra isolation material onto outer surface of rotary kiln. A European patent document numbered EP2799800B1 studies prevention of heat loss by arranging vacuum isolation panels outside kiln but it is not useful as the said material is much more conductive than vacuum environment. A Chinese patent numbered CN102818449A discloses application of vacuum to some areas inside the kiln. However, it does not have an aim of preventing heat loss.

Although there are various studies in the related art, in present case none of them shows result of needed effectiveness and practical level. The known technique is inadequate to prevent heat loss from the surface. The solutions offered for prevention of heat loss from rotary kiln surface do not go beyond reducing heat loss by regaining of lost heat or use of isolation material.

As a result due to inadequacy of existing solutions it has been necessary to make development in the related art in order to prevent and eliminate the problems in the field.

### PURPOSE OF THE INVENTION

The present invention relates to a rotary kiln system with vacuum surface meeting the needs mentioned above, eliminating all disadvantages and providing some additional advantages.

The primary purpose of the invention is to develop a system providing keeping or use of all heat inside by means of vacuum system.

Another purpose of the invention is to develop a system preventing waste of high amount of energy.

A further purpose of the invention is to provide less carbon (or fuel-oil) and thus less CO₂ release.

Another purpose of the invention is to enable partial application of this invention to existing kilns other than production of new kilns.

In order to achieve above mentioned purposes, the invention is a rotary kiln system with vacuum surface comprising a metal or polymer or composite jacket coated onto inner and/or outer surface to make rotary kiln double walled, a vacuum area remaining between outer surface of the rotary kiln and jacket where vacuuming operation is conducted, air sealing members providing joining of outer surface of rotary kiln and inner surface of the jacket; it provides instant monitoring of temperature at inner surface of kiln by temperature sensors located preferably on internal surface of the jacket.

The structural and characteristics features of the invention and all advantages will be understood better in figures and detailed descriptions and figures given below and therefore, the assessment should be made taking into account the detailed explanations and the figures.

### BRIEF DESCRIPTION OF THE DRAWINGS

FIG. 1—is view of rotary kiln system with vacuum surface

### DESCRIPTION OF REFERENCES

1 Outer surface
2 Jacket
3 refractory block
4 Hole
5 Sealing members
6 Vacuum area
7 Temperature Meters

### DETAILED DESCRIPTION OF THE INVENTION

In this detailed description, the subject of the invention is described in a manner not forming any restrictive effect and only for purpose of better understanding of the matter.

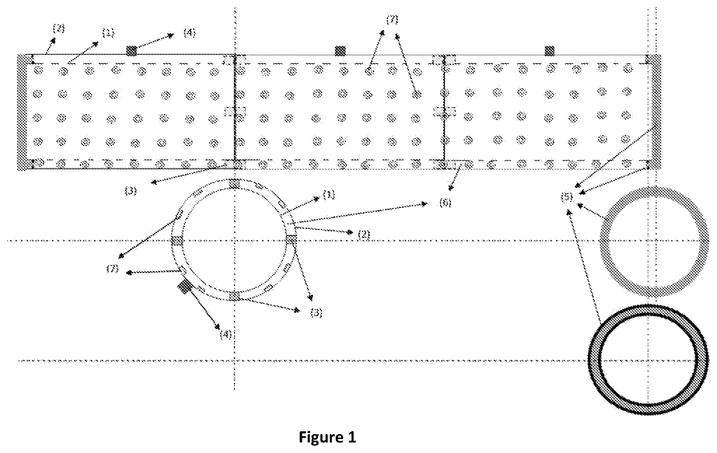

Rotary kiln system with vacuum surface of the invention of which an illustrative view is given in FIG. 1 in the most basic form comprises
a metal or polymer or composite jacket (2) coated onto inner and/or outer surface (1) to make rotary kiln double walled;
a vacuum area (6) remaining between outer surface (1) of the rotary kiln and the jacket (2) where vacuuming operation is applied
air sealing members (5) providing joining of outer surface (1) of rotary kiln and inner surface of the jacket (2)
aluminium folio/layer (sheet) preferably coated onto inner surface of metal jacket
infrared temperature meters (7) preferably placed inside outer tube to measure temperature values on surface of the tube inside, solar panels batteries onto outer tube surface to meet power needs of temperature meters (7).

In the invention, a jacket (2), which is taken into vacuum, taking area outside rotary kiln and the jacket (2) keeps outer surface (1) of rotary kiln under vacuum. Thus, loss of most or all of the heat lost from 300° C. outer surface is prevented. In addition, keeping kiln at 900° C. with less energy (at higher temperatures subject to refractory laying and generated heat) is provided. It is the lowest heat conductivity medium depending on vacuum degree, The less the gas molecules to conduct heat the harder the heat is conducted and the heat can not go out of the vacuumed environment surrounding it or can leave at minimum level. Refractory blocks (3) of low heat conductivity are placed between the jacket (2) and rotary kiln outer surface (1). Thus, the distance between the jacket (2) and outer surface (1) of the rotary kiln remains constant. As refractory blocks (3) are blocks of low thermal conductivity, heat loss from such points are also minimized. Metal jacket (2) and rotary kiln outer surface (1) are joined by sealing members (5) from both ends. Sealing members (5) comprises titanium or stainless steel or aluminium and copper rings. The sealing members (5) prevent leakage of air and provides protection of vacuum in the system. Thus, vacuum area (6) which is the area between outer surface (1) of the rotary kiln and the jacket (2), can be taken into vacuum. Vacuum area (6) is established by vacuum pumps located at least at one point of the outer jacket (1) and placed in the holes (4) that enable the vacuuming operation to be performed. When desired vacuum value is achieved, vacuum pumps located at the holes (4) are turned off by means of a valve. In a preferred embodiment of the invention, barometers are placed to the holes and vacuum value therein can be observed instantly. Also, with temperature meters (7) placed onto inner surface of the jacket, temperature values of inner surface of kiln can be measured instantly.

With the developed invention, a layer (metal jacket (2)) is additionally added onto outside of kiln outer surface (1) and the air therein is absorbed and thus vacuum environment is provided, which can be applied to systems losing heat from outer surface. Thus, heat loss from surface is fully prevented by help of this vacuum system. The invention provides less carbon (or fuel-oil) and thus less CO₂ release. Energy consumption is minimized by heat preservation. As the invention can be applied to current rotary kilns, it is not needed to produce new rotary kilns. In addition, the invention can also be applied to new rotary kiln production. Energy saving achieved with the invention is not one time saving but continues as long as factory production continues.

1. A rotary kiln system with a vacuum surface comprising:
a metal or polymer or composite jacket coated onto an inner and/or outer surface to make the rotary kiln double walled;
a vacuum area remaining between the outer surface of the rotary kiln and the jacket where vacuuming operation is applied; and
air sealing members providing the joining of the outer surface of the rotary kiln and the inner surface of the jacket.

2. The system according to claim 1, wherein the inner surface of the jacket being is aluminium folio or layer coated.

3. The system according to claim 1, wherein air in the vacuum area is taken into the vacuum and filled with xenon or dichlorofluoromethane or trichloromethane or sulfur dioxide gas and re-vacuumed.

4. The system according to claim 1, further comprising holes located in at least one point of the jacket, enabling the vacuuming process to be formed in order to form the vacuum area, with at least one vacuum pump and valve connected to said holes.

5. The system according to claim 1, further comprising refractory blocks located between the jacket and the inner surface to provide a fixed distance between them.

6. The system according to claim 1, wherein the sealing members comprise titanium or steel or iron or stainless steel or aluminium and copper rings.

7. The system according to claim 1, further comprising infrared temperature meters placed inside an outer tube to measure temperature values on surface of the tube inside and solar panel and batteries located onto outside of the jacket to meet the power needs of said temperature meters.
